(19) United States
(12) Patent Application Publication
(10) Pub. No.: US 2024/0154508 A1
(43) Pub. Date: May 9, 2024

(54) BRUSHLESS MOTOR

(71) Applicant: Hanon Systems, Daejeon (KR)

(72) Inventors: Seong Kook CHO, Daejeon (KR); Hyeon Jae SHIN, Daejeon (KR); Ho Bin IM, Daejeon (KR)

(21) Appl. No.: 18/281,973

(22) PCT Filed: Mar. 18, 2022
(86) PCT No.: PCT/KR2022/003792

§ 371 Date: Sep. 14, 2023

(30) Foreign Application Priority Data
Apr. 27, 2021 (KR) 10-2021-0054205

(51) Int. Cl. H02K 29/03; H02K 1/276; H02K 21/16

(52) U.S. Cl. CPC H02K 29/03; H02K 1/276; H02K 21/16

(57) ABSTRACT

The present invention relates to a brushless motor, and more particularly, to a brushless motor capable of cogging torque and torque ripples of the motor by means of design structures such as a shape of an opposing surface of a pole shoe, a shape of an outer circumferential surface of a rotor, and shapes and arrangement of permanent magnets.

### TECHNICAL FIELD

The present invention relates to a brushless motor, and more particularly, to a brushless motor capable of cogging torque and torque ripples of the motor by means of design structures such as a shape of an opposing surface of a pole shoe, a shape of an outer circumferential surface of a rotor, and shapes and arrangement of permanent magnets.

### BACKGROUND ART

A brushless direct current (BLDC) motor may have relatively high efficiency and prevent friction and abrasion that are problems of a direct current motor in the related art. Therefore, recently, the BLDC motor has been applied, as a motor for rotating a cooling fan, to a hybrid vehicle.

The BLDC motor refers to a motor in which an electronic commutation mechanism is installed instead of a brush and a commutator eliminated from the DC motor. Further, among the BLDC motors, an inner-rotor-type BLDC motor has a rotor having permanent magnets at a center thereof and configured to rotate, and a stator around which a drive coil is wound is fixed. That is, the stator around which the drive coil is wound is fixed to an outer side of the rotor, and the rotor having the permanent magnets provided therein is configured to rotate.

FIG. 1 is a cross-sectional view schematically illustrating a brushless motor in the related art. As illustrated, in a brushless motor 1 in the related art, a rotor 5 is disposed inside a stator 2 and spaced apart from the stator 2 at a predetermined interval. The stator 2 is formed in a ring shape, a plurality of teeth 3 protrudes inside the stator 2 and disposed radially. Drive coils are wound around the teeth 3, and pole shoes 4 are formed at inner ends of the teeth 3 adjacent to the rotor 5. In addition, a plurality of permanent magnets 6 is coupled to the rotor 5, and the permanent magnets 6 are disposed to be spaced apart from one another in a circumferential direction.

However, in the brushless motor, a magnitude of magnetic resistance (a degree to which a flow of magnetic flux is hindered) varies depending on a rotation position when the rotor rotates. A pulsation of motor torque occurs because of a difference in magnetic resistance. In the permanent magnet-type motor, the pulsation of torque, which occurs when the rotor rotates before electricity is applied to the coil of the motor, is referred to as cogging torque. Because of the pulsation of torque, the motor has an excitation source against vibration and noise, which eventually causes noise of the motor that may affect a cooling fan that is a system configured to operate by using the motor.

Accordingly, there is a need to improve noise and vibration characteristics of the motor by reducing torque ripples that are fluctuation widths of cogging torque of the brushless motor.

### DOCUMENT OF RELATED ART

Korean Patent No. 1603667 (registered on Mar. 9, 2016)

### DISCLOSURE

### Technical Problem

The present invention has been made in an effort to solve the above-mentioned problem, and an object of the present invention is to provide a brushless motor capable of cogging torque and torque ripples of the motor by means of design structures such as a shape of an opposing surface of a pole shoe, a shape of an outer circumferential surface of a rotor, and shapes and arrangement of permanent magnets.

### Technical Solution

The present invention provides a brushless motor including: a stator in which a plurality of teeth is provided inside a stator core and spaced apart from one another, and pole shoes respectively formed at tips of the teeth; and a rotor rotatably disposed inside the stator and having a plurality of permanent magnets, in which an opposing surface of the pole shoe, which faces the rotor, is formed in a curved shape having one or more constant curvatures, and in which the rotor is formed in an anisotropic circular shape in which a distance between an outer circumferential surface of the rotor and a rotation center of the rotor varies depending on a position of the outer circumferential surface of the rotor.

The rotor may be configured such that a distance from the rotation center of the rotor to the outer circumferential surface of the rotor along a q-axis of the rotor is smaller than a distance from the rotation center of the rotor to the outer circumferential surface of the rotor along a d-axis of the rotor, and an outer circumferential surface of the rotor adjacent to the d-axis of the rotor has an arc shape.

A portion where the outer circumferential surface of the rotor adjacent to the d-axis of the rotor has the arc shape may be defined as a d-axis rotor portion, and a radius of curvature of the d-axis rotor portion may be smaller than a distance from the rotation center of the rotor to the d-axis rotor portion.

In the brushless motor according to the first embodiment of the present invention, the opposing surface of the pole shoe may be formed in an arc shape formed concavely inward.

A center of curvature of the opposing surface of the pole shoe may be positioned on the same line as a width direction centerline of each of the teeth. A radius of curvature of the opposing surface of the pole shoe may be larger than a radius of curvature of the d-axis rotor portion.

A radius of curvature of the opposing surface of the pole shoe may be larger than a distance from the rotation center of the rotor to the outer circumferential surface of the rotor.

In the brushless motor according to the second embodiment of the present invention, one side and the other side of the opposing surface of the pole shoe may each be formed in an arc shape based on a width direction center of the pole shoe.

One side of the opposing surface of the pole shoe may be defined as a first arc portion based on the width direction center of the pole shoe, the other side of the opposing surface of the pole shoe may be defined as a second arc portion based on the width direction center of the pole shoe, and a radius of curvature of the first arc portion and a radius of curvature of the second arc portion may be equal to each other.

A line, which connects a circumferential center of the first arc portion and a center of curvature of the first arc portion, and a line, which connects a circumferential center of the second arc portion and a center of curvature of the second arc portion, may be parallel to each other.

A line, which connects a circumferential center of the first arc portion and a center of curvature of the first arc portion, and a line, which connects a circumferential center of the second arc portion and a center of curvature of the second arc portion, may define a predetermined angle therebetween so as to meet at an upper side of the opposing surface of the pole shoe.

A line, which connects a circumferential center of the first arc portion and a center of curvature of the first arc portion, and a line, which connects a circumferential center of the second arc portion and a center of curvature of the second arc portion, may define a predetermined angle therebetween so as to meet at a lower side of the opposing surface of the pole shoe.

The first arc portion and the second arc portion may be symmetric with respect to a width direction centerline of each of the teeth.

A radius of curvature of the first arc portion and a radius of curvature of the second arc portion may each be larger than a radius of curvature of the d-axis rotor portion.

In the brushless motor according to the example of the present invention, the plurality of permanent magnets may each include a pair of unit permanent magnets, and the pair of unit permanent magnets may each be a straight permanent magnet.

The pair of unit permanent magnets may be disposed in a V shape toward the rotation center of the rotor, and an angle between the pair of unit permanent magnets may be 130° or more and 140° or less.

The plurality of permanent magnets may each be a straight permanent magnet.

In the brushless motor according to the present invention, the outer circumferential surface of the rotor may have convex surfaces and concave surfaces formed alternately in a circumferential direction, the plurality of permanent magnets may each be disposed inside the convex surface, and the two adjacent permanent magnets may be symmetric with respect to the concave surface positioned between the two adjacent permanent magnets.

An end of a flux barrier of the rotor may be formed in parallel with the outer circumferential surface of the rotor, such that a rotor bridge has a constant thickness.

In the brushless motor according to the present invention, twelve teeth may be provided inside the stator core, and eight permanent magnets may be provided in the rotor.

### Advantageous Effects

According to the present invention, the size of the air gap may vary depending on the position according to the rotation of the rotor, thereby greatly reducing the magnetic resistance according to the change in position of the air gap. Therefore, it is possible to innovatively reduce the cogging torque of the motor and implement a counter electromotive force waveform having a maximum sinusoidal shape by reducing a distortion rate against a spatial high harmonic wave of a counter electromotive force. Therefore, it is possible to reduce the torque ripple, reduce noise caused by the spatial high harmonic wave generated in the motor, and properly maintain a motor control algorithm that follows the counter electromotive force waveform.

In addition, the temporal change in magnetic flux may be maintained at a minimum level to reduce the temporal change in magnetic flux interlinking the permanent magnets. Therefore, it is possible to reduce a loss of eddy current of the permanent magnet, improve the energy efficiency of the motor, reduce energy consumption, and improve the performance of the motor.

### BRIEF DESCRIPTION OF THE DRAWINGS

FIG. 1 is a cross-sectional view schematically illustrating a brushless motor in the related art.

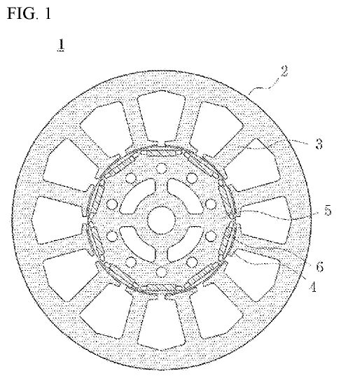

FIG. 2 is a cross-sectional view schematically illustrating a brushless motor according to an example of the present invention.

FIG. 3 is a view illustrating the comparison between the present invention illustrated in FIG. 2 and the technology in the related art.

FIG. 4 is a view illustrating FIG. 2 again.

FIGS. 5 and 6 are cross-sectional views for explaining a pole shoe according to a first embodiment of the present invention.

FIG. 7 is an enlarged cross-sectional view of a pole shoe according to a second embodiment of the present invention.

FIG. 8 is an enlarged cross-sectional view illustrating another pole shoe according to the second embodiment of the present invention.

FIG. 9 is an enlarged cross-sectional view illustrating another pole shoe according to the second embodiment of the present invention.

FIG. 10 is a view for explaining a relationship between a rotor and a stator of the present invention.

FIG. 11 is a graph illustrating the comparison between cogging torque of a motor in the related art and cogging torque of a motor of the present invention.

FIGS. 12 and 13 are graphs illustrating the comparison between a torque ripple of the motor in the related art and a torque ripple of the motor of the present invention.

FIG. 14 is a view for explaining permanent magnets according to the example of the present invention.

FIG. 15 is a view for explaining permanent magnets according to another example of the present invention.

### MODE FOR INVENTION

Hereinafter, the present invention will be described with reference to the accompanying drawings.

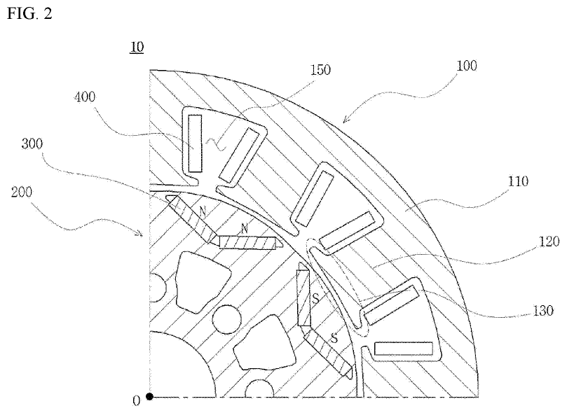

FIG. 2 is a cross-sectional view schematically illustrating a brushless motor according to an example of the present invention and illustrating one quadrant of the entire cross-section of the motor. As illustrated, a brushless motor 10 of the present invention may have a cylindrical shape and thus have a circular cross-section. A stator 100 may be provided at an outer side, and a rotor 200 may be provided at an inner side. The stator 100 may include a stator core 110, and a plurality of teeth 120 provided inside the stator core and spaced apart from one another. Pole shoes 130 may be respectively formed at tips of the teeth 120. A coil 400 may be wound around each of the teeth 120, and an electric current may be applied to the coil 400. A slot 150, which is an empty space, may be formed between the adjacent teeth 120. The pole shoe 130 may extend from the tip of each of the teeth 120 by a predetermined distance toward two opposite circumferential sides.

The rotor 200 may be rotatably disposed inside the stator 100 and have a plurality of permanent magnets 300. The permanent magnets 300 may be individually seated in slits 250 formed in the rotor 200 and radially disposed inside an outer circumferential surface of the rotor 200.

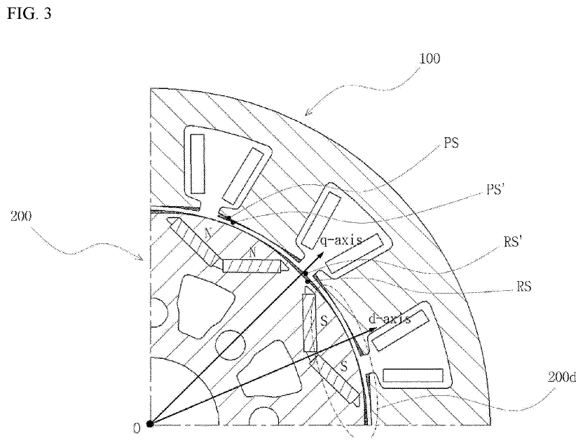

FIG. 3 is a view illustrating the comparison between the present invention illustrated in FIG. 2 and the related art. As illustrated in the part indicated by the dotted line in FIG. 3, in a general rotor in the related art, an outer circumferential surface RS′ of the rotor is formed in a completely circular shape, and an opposing surface PS′ of the pole shoe facing the rotor is formed in an arc shape having the same curvature as the outer circumferential surface of the rotor so as to have the constant interval from the outer circumferential surface of the rotor.

In contrast, in the present invention, as illustrated in FIG. 3, an outer circumferential surface RS of the rotor may be formed in an anisotropic circular shape (anisotropic rotor) instead of a completely circular shape, and an opposing surface PS of the pole shoe may have a curved shape (curved pole shoe chamfer).

First, the rotor 200 of the present invention will be specifically described. With reference back to FIGS. 2 and 3, the rotor 200 according to the present invention may have a shape in which a distance between the outer circumferential surface RS of the rotor and a rotation center O of the rotor varies depending on a position of the outer circumferential surface RS of the rotor. That is, as described above, the outer circumferential surface of the rotor 200 of the present invention is not formed in a completely circular shape, unlike the outer circumferential surface RS′ of the rotor in the related art. The outer circumferential surface of the rotor 200 may be formed in an anisotropic circular shape in which one portion is more convexly formed than the other portion, and the other portion is more concavely formed than one portion.

More specifically, the outer circumferential surface RS of the rotor according to the present invention has convex surfaces convexly formed, and concave surfaces concavely formed, and the convex surfaces and the concave surfaces are alternately formed in the circumferential direction. In this case, as illustrated, in the present invention, the plurality of permanent magnets 300 may be respectively provided inside the convex surfaces of the outer circumferential surface of the rotor. Therefore, the convex surface of the outer circumferential surface RS of the rotor corresponds to a d-axis of the rotor, and the concave surface of the outer circumferential surface RS of the rotor corresponds to a q-axis of the rotor. The number of convex surfaces of the outer circumferential surface RS of the rotor may be equal to the number of permanent magnets 300.

The d-axis of the rotor is an axis along which the magnetic flux is concentrated. The d-axis corresponds to a line that connects a magnetic pole portion and the rotation center O of the rotor, i.e., a line that connects centers of the permanent magnets 300. The q-axis of the rotor is an axis orthogonal to the d-axis at an electrical angle and corresponds to a line that connects the rotation center O of the rotor and a center between the adjacent permanent magnets 300 spaced apart from each other. That is, in the rotor 200 of the present invention, a distance from the rotation center O of the rotor to the outer circumferential surface RS of the rotor along the q-axis may be shorter than a distance from the rotation center O of the rotor to the outer circumferential surface RS of the rotor along the d-axis.

Because the outer circumferential surface RS of the rotor is formed in an anisotropic circular shape as described above, a size of an air gap between the rotor 200 and the stator 100 periodically changes when the rotor 200 rotates, such that a change in magnetic resistance according to a change in position of the air gap may be reduced. The anisotropic circular shape of the outer circumferential surface RS of the rotor may be coupled to the shape of the opposing surface RS of the rotor of the present invention to be described below, thereby maximizing the effect of reducing a magnetic resistance change rate.

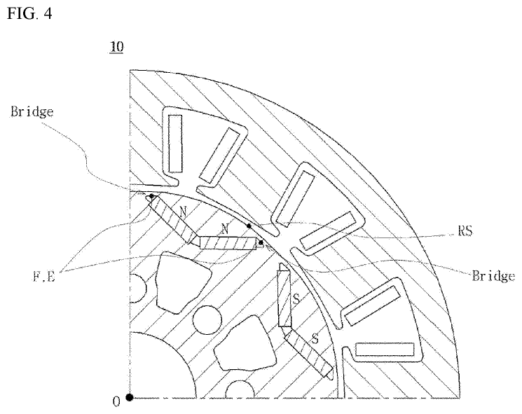

However, even when the outer circumferential surface RS of the rotor of the present invention is formed in an anisotropic circular shape, a shape of a flux barrier may be appropriately implemented to maintain a constant thickness of a rotor bridge. More specifically, FIG. 4 is a view illustrating FIG. 2 again. As illustrated, in the present invention, ends F and E of the flux barrier of the rotor are provided in parallel with the outer circumferential surface RS of the rotor, such that the thickness of the rotor bridge may be constantly formed. For example, a distance between each of the ends F and E of the flux barrier and the outer circumferential surface RS of the rotor may be constantly set to 0.5 mm or less.

Next, the pole shoe 130 according to the present invention will be described. As described above, the opposing surface PS of the pole shoe 130 of the present invention may be formed in a curved shape. The curved shape will be described with reference to the specific embodiment.

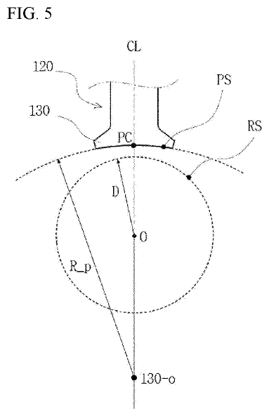

First, a pole shoe according to a first embodiment of the present invention will be described with reference to FIGS. 5 and 6. FIGS. 5 and 6 are cross-sectional views for explaining the pole shoe according to the first embodiment of the present invention. As illustrated, the opposing surface PS of the pole shoe 130 of the present example may be formed in an arc shape formed concavely inward.

The pole shoe of the present example may be formed in an arc shape formed concavely inward in the opposing surface of the pole shoe over the entire opposing surface of the pole shoe. Therefore, the pole shoe may have a curved surface having a constant curvature from one end to the other end of the opposing surface of the pole shoe.

In this case, as illustrated in FIGS. 5 and 6, a center 130-o of curvature of the opposing surface of the pole shoe may be positioned on the same line as a width direction centerline CL of each of the teeth, such that the opposing surface PS of the pole shoe is symmetric with respect to the width direction centerline CL of each of the teeth. The center 130-o of curvature of the opposing surface PS of the pole shoe corresponds to an imaginary center of a circle made by extending the opposing surface of the pole shoe that has a constant curvature and defines an arc.

Further, in the present example, a radius R_p of curvature of the opposing surface CL of the pole shoe may be larger than a radius R_d of a d-axis rotor portion and larger than a distance D from the rotation center O of the rotor to the outer circumferential surface RS of the rotor. That is, as illustrated in FIG. 5, the radius R_p of curvature of the opposing surface CL of the pole shoe, the distance D from the rotation center O of the rotor to the outer circumferential surface RS of the rotor, and the radius R_d of the d-axis rotor portion may satisfy the following relationship. R_p>D>R_d. With the above-mentioned configuration, the distance between the opposing surface of the pole shoe and the outer circumferential surface of the rotor may be smallest at a circumferential center of the opposing surface of the pole shoe and gradually increase toward two opposite ends. The shape in which the distance changes may be more noticeable near the d-axis of the rotor.

In this case, all the rotation center O of the rotor, a center 200d-o of curvature of the d-axis rotor portion, and the center 130-o of curvature of the opposing surface of the pole shoe may be disposed on a straight line and coincident with the width direction centerline CL of each of the teeth.

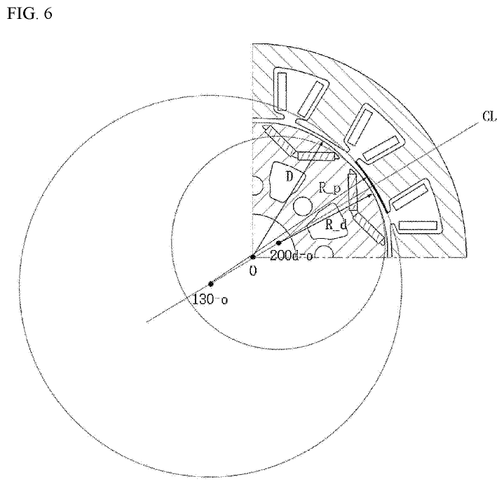

Next, a pole shoe according to a second embodiment of the present invention will be described with reference to FIGS. 7 to 10. FIG. 7 is an enlarged cross-sectional view of the pole shoe according to the second embodiment of the present invention. As illustrated, one side and the other side of the opposing surface PS of the pole shoe 130 of the present example, which faces the rotor 200, may each be formed in an arc shape based on a width direction center PC of the pole shoe.

The width direction center PC of the pole shoe may mean a center of the opposing surface PS of the pole shoe. The width direction center PC may be coincident with the width direction centerline CL of each of the teeth 120, and the width direction centerline CL of the teeth 120 may pass through the rotation center O of the rotor. Hereinafter, based on the width direction center PC of the pole shoe, one side (a left side based on the drawings) of the opposing surface PS of the pole shoe will be referred to as a first arc portion A, and the other side (a right side based on the drawings) of the opposing surface PS of the pole shoe will be referred to as a second arc portion B.

In the present invention, the opposing surface PS of the pole shoe may have the first arc portion A and the second arc portion B respectively formed at one side and the other side based on the center PC. Therefore, the air gap between the opposing surface PS of the pole shoe and the outer circumferential surface RS of the rotor may vary depending on the positions. More specifically, the first arc portion A is formed from one end of the opposing surface of the pole shoe to the width direction center PC of the pole shoe in the rotation direction of the rotor, such that the air gap between the first arc portion A and the outer circumferential surface RS of the rotor may vary depending on the positions. The second arc portion B is formed from the width direction center PC of the pole shoe to the other end of the opposing surface of the pole shoe, such that the air gap between the second arc portion B and the outer circumferential surface of the rotor may vary depending on the positions. According to the present invention described above, the air gap may vary twice depending on the positions on the single pole shoe 130.

This is to reduce cogging torque. In the present invention described above, the shape design of the pole shoe may intentionally increase the change in air gap between the opposing surface PS of the pole shoe and the outer circumferential surface RS of the rotor, thereby minimizing a magnetic resistance change rate in the air gap between the two adjacent pole shoes.

$${T}_{Cogging} = - \frac{1}{2} {ϕ}_{g}^{2} \frac{dR}{d θ} \qquad Equation 1$$

(Here, Tcogging means cogging torque, Φg means interlinkage magnetic flux, R means magnetic resistance, and θ means a rotation angle.)

Equation 1 is an equation for calculating cogging torque in the motor. As shown in Equation 1, the cogging torque is proportional to the square of the amount of interlinkage magnetic flux Φg passing through the air gap and proportional to the magnetic resistance change rate (dR/dθ) according to the change in position of the air gap. Therefore, eventually, it is possible to minimize the magnetic resistance change rate in the air gap to reduce the cogging torque. According to the present invention, the air gap varies depending on the position on the opposing surface PS of the pole shoe, such that the magnetic resistance R and the magnetic resistance change rate (dR/dθ) may be reduced, and thus the cogging torque and the torque ripple, which is a range of fluctuation of the cogging torque, may be reduced.

Hereinafter, more specified embodiments of the pole shoe 130 of the present example will be described. As described above, the opposing surface PS of the pole shoe 130 of the present example may include the first arc portion A and the second arc portion B. In this case, a first connection line AL, which is a line that connects a circumferential center A-c of the first arc portion A and a center A-o of a circle made by extending the first arc portion A, and a second connection line BL, which is a line that connects a circumferential center B-c of the second arc portion B and a center B-o of a circle made by extending the second arc portion B, may be parallel to each other or define a predetermined angle therebetween.

With reference back to FIG. 7, the circumferential center A-c of the first arc portion A corresponds to a center between the width direction center PC of the pole shoe and one end of the opposing surface of the pole shoe, and the center of the circle made by extending the first arc portion A corresponds to a center (i.e., a center of curvature of the arc portion) of an imaginary circle made by extending the first arc portion while maintaining the curvature of the first arc portion A. The circumferential center B-c of the second arc portion B corresponds to a center between the width direction center PC of the pole shoe and the other end of the opposing surface of the pole shoe, and the center B-o of the circle made by extending the second arc portion B corresponds to a center of an imaginary circle made by extending the second arc portion while maintaining the curvature of the second arc portion.

In this case, in the example illustrated in FIG. 7, the first connection line AL and the second connection line BL may be parallel to each other. In this case, one end, the center, and the other end of the opposing surface PS of the pole shoe may be formed on the same line.

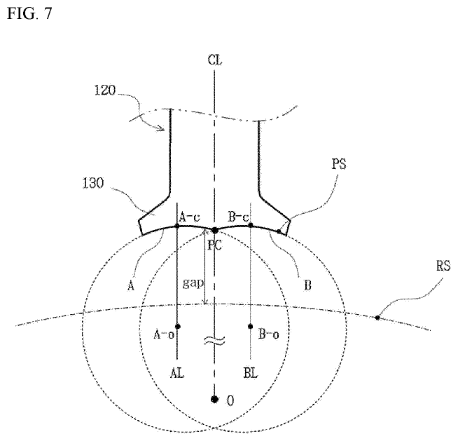

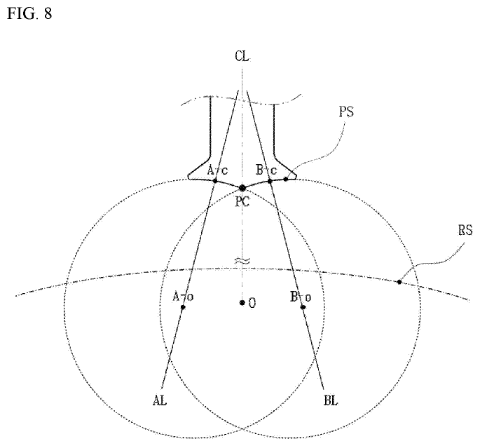

FIGS. 8 and 9 are enlarged cross-sectional views of the pole shoe according to another example of the present invention. In the present example, the first connection line AL and the second connection line BL may define a predetermined angle therebetween. In this case, FIG. 8 illustrates a shape of the opposing surface PS of the pole shoe when a point at which the first connection line AL and the second connection line BL meet is provided outside the opposing surface of the pole shoe, i.e., provided at an upper side of the opposing surface of the pole shoe based on the opposing surface of the pole shoe. FIG. 9 illustrates a shape of the opposing surface PS of the pole shoe when the point at which the first connection line AL and the second connection line BL meet is provided inside the opposing surface of the pole shoe, i.e., provided at a lower side of the opposing surface of the pole shoe based on the opposing surface of the pole shoe. In this case, one end, the center, and the other end of the opposing surface PS of the pole shoe may not be formed on the same line. In FIG. 7, a height of the center PC of the opposing surface of the pole shoe may be lower than a height of each of the two opposite ends of the opposing surface of the pole shoe. In FIG. 8, a height of the center PC of the opposing surface of the pole shoe may be higher than a height of each of the two opposite ends of the opposing surface of the pole shoe.

Further, in the above-mentioned examples, as illustrated in FIGS. 7 to 9, the first arc portion A and the second arc portion B may be formed symmetrically with respect to the width direction centerline CL of each of the teeth. According to the present invention described above, it is possible to reduce the change in magnetic flux and the magnetic resistance change rate by changing the air gap between the opposing surface of the pole shoe and the outer circumferential surface of the rotor for the respective positions by designing the shape of the opposing surface of the pole shoe through various methods.

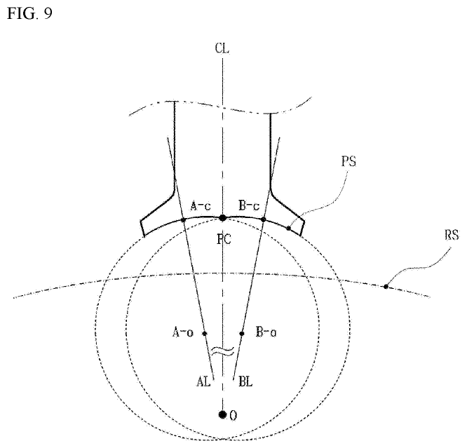

FIG. 10 is a view for explaining a relationship between the rotor and the stator of the present invention. As illustrated, in the present invention, the outer circumferential surface RS of the rotor adjacent to the d-axis of the rotor may have an arc shape having a predetermined curvature while having a predetermined radius. In this case, when the portion, where the outer circumferential surface of the rotor adjacent to the d-axis of the rotor has an arc shape as described above, is defined as a d-axis rotor portion 200d, a radius R_d of the d-axis rotor portion 200d may be smaller than the distance D from the rotation center O of the rotor to the d-axis rotor portion 200d. That is, the outer circumferential surface RS of the rotor of the present invention may have an arc shape having a relatively small radius along the d-axis and have a shape in which the two adjacent arc shapes along the d-axes adjoin each other along the q-axis positioned therebetween.

Further, in the present invention, a radius R_A of the first arc portion A, which corresponds to one side of the opposing surface RS of the pole shoe, and a radius R_B of the second arc portion B, which corresponds to the other side of the opposing surface RS of the pole shoe, may each be larger than the radius R_d of the d-axis rotor portion 200d. With reference back to FIG. 10, the radius R_A of the first arc portion A and the radius R_B of the second arc portion B may each be larger than the radius R_d of the d-axis rotor portion 200d. In FIG. 10, 200d-o indicates a center of a circle made by extending the d-axis rotor portion 200d. In this case, the radius R_A of the first arc portion and the radius R_B of the second arc portion may be equal to each other. As described above, the first arc portion A and the second arc portion B may be formed symmetrically with respect to the width center CL of each of the teeth 120.

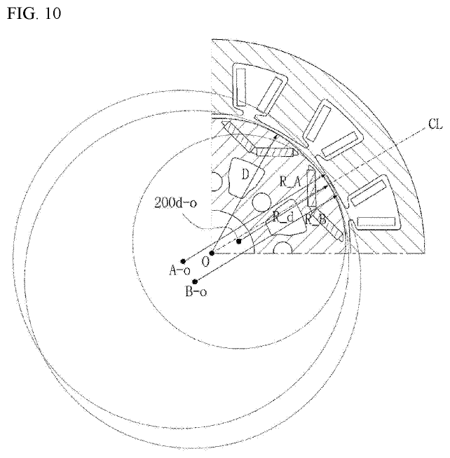

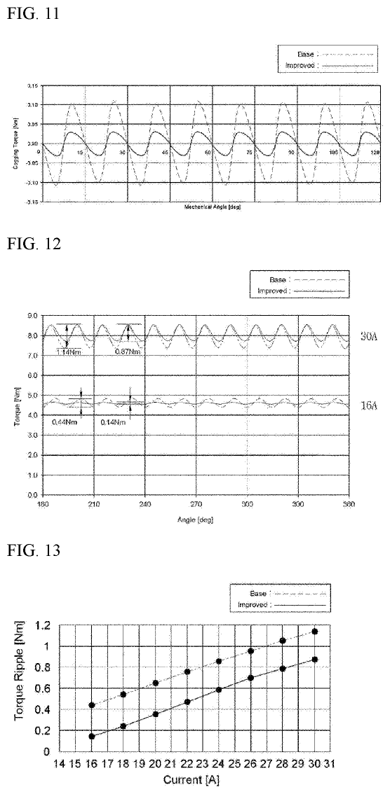

FIG. 11 is a graph illustrating the comparison between cogging torque of a motor in the related art and cogging torque of a motor of the present invention, and FIGS. 12 and 13 are graphs illustrating the comparison between a torque ripple of the motor in the related art and a torque ripple of the motor of the present invention.

As illustrated in FIG. 11, it can be ascertained that in the case of the motor (base) in the related art, a magnitude of cogging torque is about 0.215 (Nm) as the cogging torque changes within about ±0.11, whereas in the case of the motor (improved) of the present invention, a magnitude of cogging torque is about 0.06 (Nm) as the cogging torque changes within about ±0.03, and thus the magnitude of cogging torque is reduced by about 72% in comparison with the related art.

Further, as illustrated in FIG. 12, it can be ascertained that a torque ripple of about 1.14 Nm occurs in the motor (base) in the related art when a relatively high electric current of 30 A is applied to the motor, whereas a torque ripple of about 0.87 Nm, which is smaller than the torque ripple of about 1.14 Nm, occurs in the motor (improved) of the present invention. Further, it can be ascertained that a torque ripple of about 0.44 Nm occurs in the motor (base) in the related art when a relatively low electric current of 16A is applied to the motor, whereas a torque ripple of about 0.14 Nm, which is smaller than the torque ripple of about 0.44 Nm, occurs in the motor (improved) of the present invention. In addition, as illustrated in FIG. 13, it can be ascertained that a size of the torque ripple is smaller in the present invention (improved) than in the related art (base) over the entire section for respective intensities of the electric current applied to the motor.

As described above, in the present invention, the stator, more specifically, the opposing surface of the pole shoe and the outer circumferential surface of the rotor are designed to have the above-mentioned shapes and structures, such that the size of the air gap may vary depending on the position according to the rotation of the rotor, thereby greatly reducing the magnetic resistance according to the change in position of the air gap. Therefore, it is possible to innovatively reduce the cogging torque of the motor and implement a counter electromotive force waveform having a maximum sinusoidal shape by reducing a distortion rate against a spatial high harmonic wave of a counter electromotive force. Therefore, it is possible to reduce the torque ripple, reduce noise caused by the spatial high harmonic wave generated in the motor, and properly maintain a motor control algorithm that follows the counter electromotive force waveform.

In addition, the temporal change in magnetic flux may be maintained at a minimum level to reduce the temporal change in magnetic flux interlinking the permanent magnets. Therefore, it is possible to reduce a loss of eddy current of the permanent magnet, improve the energy efficiency of the motor, reduce energy consumption, and improve the performance of the motor.

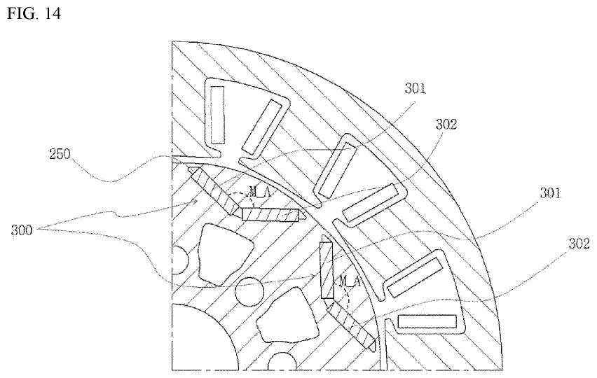

Hereinafter, the permanent magnet 300 of the present invention will be described. FIG. 14 is a view illustrating FIG. 2 again, i.e., a view for explaining the permanent magnet according to the example of the present invention. As illustrated, the permanent magnets 300 may be individually mounted in the slits 250 formed in the outer circumferential surface of the rotor 200, and the permanent magnets 300 may be disposed radially on the rotor 200.

The permanent magnets 300 according to the example of the present invention may each include a pair of unit permanent magnets 301 and 302. In this case, the pair of unit permanent magnets 301 and 302 may each be a straight permanent magnet. As illustrated in FIG. 13, the straight permanent magnet is a magnet having a straight cross-sectional shape. The straight permanent magnet may have a shape in which a plurality of magnetic thin plates is stacked in a stacking direction of the cross-section or the entire magnet are integrated.

In this case, as illustrated in FIG. 14, the pair of unit permanent magnets 301 and 302 may be disposed in a V shape toward a rotation center of the rotor. An angle M_A defined between the pair of unit permanent magnets 301 and 302 may be 130° or more and 140° or less. Because the permanent magnet includes the pair of unit permanent magnets and the pair of unit permanent magnets is disposed at a predetermined angle as described above, such that the intensity of the magnetic flux concentrated along the d-axis may be increased.

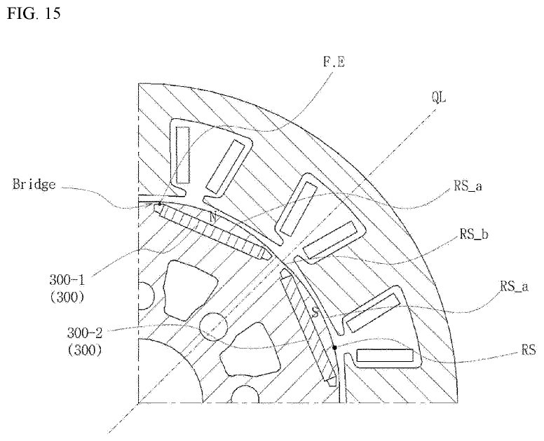

Alternatively, according to another example of the present invention, the permanent magnets 300 may each be configured as a straight permanent magnet. FIG. 15 is a view for explaining a permanent magnet according to another example of the present invention. As illustrated in FIG. 15, the permanent magnet 300 may be configured as a single straight permanent magnet instead of the pair of unit permanent magnets. In this case, the permanent magnets 300 are disposed to be more adjacent to the outer circumferential surface RS of the rotor, such that the amount of interlinkage magnetic flux may be increased, and the magnetic resistance change rate may be reduced when the rotor rotates. Even in this case, as illustrated in FIG. 15, the ends F and E of the flux barrier may be parallel to the outer circumferential surface RS of the rotor so that the rotor bridge has a constant thickness.

Meanwhile, as described above, the convex surfaces and the concave surfaces of the outer circumferential surface RS of the rotor according to the present invention may be alternately formed in the circumferential direction, and the permanent magnets 300 may each be provided inside the convex surface. In this case, the present invention may provide a structure in which the two adjacent permanent magnets, among the permanent magnets, are symmetric with respect to the concave surface positioned between the two permanent magnet. More specifically, with reference to FIG. 15, the permanent magnets 300 may each be provided inside a convex surface RS _a of the outer circumferential surface RS of the rotor. In this case, both the two adjacent permanent magnets 300-1 and 300-2 may be formed symmetrically with respect to a line QL that connects the rotation center of the rotor and a center of a concave surfaces RS_b positioned between the two permanent magnets. In this case, the line QL, which connects the center of the concave surface RS_b and the rotation center of the rotor, may, of course, be coincident with the q-axis illustrated in FIG. 3.

Further, in the motor of the present invention in the more specific embodiment of the present invention, twelve teeth 120 are provided inside the stator core 110, a total of twelve slots 150 are formed in the stator 100, eight permanent magnets 300 are provided on the rotor 200, and a total of eight poles are formed in the rotor 200, such that an inner-rotor-type motor having the eight poles and the twelve slots may be implemented.

As described above, according to the present invention, the above-mentioned specific structures and shapes of the pole shoes, the rotor, and the permanent magnets may be combined with one another, thereby innovatively reducing the cogging torque and the torque ripples generated in the motor.

While the embodiments of the present invention have been described with reference to the accompanying drawings, those skilled in the art will understand that the present invention may be carried out in any other specific form without changing the technical spirit or an essential feature thereof. Therefore, it should be understood that the above-described embodiments are illustrative in all aspects and do not limit the present invention.

### DESCRIPTION OF REFERENCE NUMERALS

10: Motor
100: Stator
110: Stator core
120: Tooth
130: Pole shoe
PS: Opposing surface of pole shoe
A: First arc portion
B: Second arc portion
150: Slot
200: Rotor
200d: d-axis rotor portion
RS: Outer circumferential surface of rotor
300: Permanent magnet
400: Coil

What is claimed is:

1. A brushless motor comprising:
a stator in which a plurality of teeth is provided inside a stator core and spaced apart from one another, and pole shoes respectively formed at tips of the teeth; and
a rotor rotatably disposed inside the stator and having a plurality of permanent magnets,
wherein an opposing surface of the pole shoe, which faces the rotor, is formed in a curved shape having one or more constant curvatures, and
wherein the rotor is formed in an anisotropic circular shape in which a distance between an outer circumferential surface of the rotor and a rotation center of the rotor varies depending on a position of the outer circumferential surface of the rotor.

2. The brushless motor of claim 1, wherein the rotor is configured such that a distance from the rotation center of the rotor to the outer circumferential surface of the rotor along a q-axis of the rotor is smaller than a distance from the rotation center of the rotor to the outer circumferential surface of the rotor along a d-axis of the rotor, and an outer circumferential surface of the rotor adjacent to the d-axis of the rotor has an arc shape.

3. The brushless motor of claim 2, wherein a portion where the outer circumferential surface of the rotor adjacent to the d-axis of the rotor has the arc shape is defined as a d-axis rotor portion, and a radius of curvature of the d-axis rotor portion is smaller than a distance from the rotation center of the rotor to the d-axis rotor portion.

4. The brushless motor of claim 3, wherein the opposing surface of the pole shoe is formed in an arc shape formed concavely inward.

5. The brushless motor of claim 4, wherein a center of curvature of the opposing surface of the pole shoe is positioned on the same line as a width direction centerline of each of the teeth.

6. The brushless motor of claim 4, wherein a radius of curvature of the opposing surface of the pole shoe is larger than a radius of curvature of the d-axis rotor portion.

7. The brushless motor of claim 4, wherein a radius of curvature of the opposing surface of the pole shoe is larger than a distance from the rotation center of the rotor to the outer circumferential surface of the rotor.

8. The brushless motor of claim 3, wherein one side and the other side of the opposing surface of the pole shoe are each formed in an arc shape based on a width direction center of the pole shoe.

9. The brushless motor of claim 8, wherein one side of the opposing surface of the pole shoe is defined as a first arc portion based on the width direction center of the pole shoe, the other side of the opposing surface of the pole shoe is defined as a second arc portion based on the width direction center of the pole shoe, and a radius of curvature of the first arc portion and a radius of curvature of the second arc portion are equal to each other.

10. The brushless motor of claim 9, wherein a line, which connects a circumferential center of the first arc portion and a center of curvature of the first arc portion, and a line, which connects a circumferential center of the second arc portion and a center of curvature of the second arc portion, are parallel to each other.

11. The brushless motor of claim 9, wherein a line, which connects a circumferential center of the first arc portion and a center of curvature of the first arc portion, and a line, which connects a circumferential center of the second arc portion and a center of curvature of the second arc portion, define a predetermined angle therebetween so as to meet at an upper side of the opposing surface of the pole shoe.

12. The brushless motor of claim 9, wherein a line, which connects a circumferential center of the first arc portion and a center of curvature of the first arc portion, and a line, which connects a circumferential center of the second arc portion and a center of curvature of the second arc portion, define a predetermined angle therebetween so as to meet at a lower side of the opposing surface of the pole shoe.

13. The brushless motor of claim 9, wherein the first arc portion and the second arc portion are symmetric with respect to a width direction centerline of each of the teeth.

14. The brushless motor of claim 9, wherein a radius of curvature of the first arc portion and a radius of curvature of the second arc portion are each larger than a radius of curvature of the d-axis rotor portion.

15. The brushless motor of claim 1, wherein the plurality of permanent magnets each includes a pair of unit permanent magnets, and the pair of unit permanent magnets is each a straight permanent magnet.

16. The brushless motor of claim 15, wherein the pair of unit permanent magnets is disposed in a V shape toward the rotation center of the rotor, and an angle between the pair of unit permanent magnets is 130° or more and 140° or less.

17. The brushless motor of claim 1, wherein the plurality of permanent magnets is each a straight permanent magnet.

18. The brushless motor of claim 1, wherein the outer circumferential surface of the rotor has convex surfaces and concave surfaces formed alternately in a circumferential direction, and
wherein the plurality of permanent magnets is each disposed inside the convex surface, and the two adjacent permanent magnets are symmetric with respect to the concave surface positioned between the two adjacent permanent magnets.

19. The brushless motor of claim 1, wherein an end of a flux barrier of the rotor is formed in parallel with the outer circumferential surface of the rotor, such that a rotor bridge has a constant thickness.

20. The brushless motor of claim 1, wherein twelve teeth are provided inside the stator core, and eight permanent magnets are provided in the rotor.
